(19) United States
(12) Patent Application Publication
(10) Pub. No.: US 2002/0189825 A1
(43) Pub. Date: Dec. 19, 2002

(54) Reciprocating drive mechanism for a turf aerator

(76) Inventor: David John Livingstone, New South Wales (AU)

Correspondence Address: J Bennett Mullinax, Dority & Manning, Post Office Box 1449, Greenville, SC, 29602-1449, US

(21) Appl. No.: 10/168,731

(22) PCT Filed: Dec. 21, 2000
(86) PCT No.: PCT/AU00/01576

(51) Int. Cl. A01B 45/02

(52) U.S. Cl. 172/21

(57) ABSTRACT

A turf aerator with a reciprocating drive mechanism comprising a substantially rigid tine leg pivotally mounted at an upper end to a drive assembly arranged to reciprocate the tine leg along its longitudinal axis, the drive assembly comprising a reciprocating drive member to which the tine leg is pivotally attached at a first point along the drive member, the drive member being pivotally connected at a second point to a first eccentric and at a third point to a second eccentric, the third point being located intermediate the first and second points and the first and second eccentrics being rotated in synchronism, to reciprocate the first point on the drive member both vertically and while reducing the extent of horizontal reciprocation of the first point on the drive member.

The present invention relates generally to greenkeeping equipment and in particular the invention provides an improved reciprocating drive for a turf aeration device.

### BACKGROUND OF THE INVENTION

It is well known that in the cultivation of turf surfaces aeration of the root system is required from time to time to relieve compaction and enable penetration of nutrients beneath the surface mat of the turf. A variety of mechanisms have been used in the past to achieve this end, all of which generally include tines carried in some type of mechanism that allows periodic spiking of the surface. These mechanisms have increased in sophistication over the years from simple tine rollers comprising a drum with a plurality of tines located pointing radially outwardly from its surface to elaborate reciprocating mechanisms.

A basic problem with tine rollers and, which has been overcome to a certain degree by some more advanced systems is that of tearing which occurs when the tine does not enter and exit the turf vertically but instead passes through an arc while it is in the ground. This action damages the turf surface and makes it less useful for its intended purpose during the period immediately following aeration. It is also highly desirable that turf aerators be able to operate quickly in order to minimise the cost of this operation and enable the operation to be performed more regularly. Another cost related factor is the reliability of the equipment which typically decreases with increased speed and is adversely affected by the typically dirty environment in which the equipment must operate, making lubricants applied to bearing surfaces become like grinding pastes which rather than increasing the life of the bearing surface tend to decrease that life rapidly.

In one prior art arrangement an aerator has a plurality of tines located at the ends of tine legs which are reciprocated by a crank shaft and arranged transversely of the aerator. The tine legs are each slidably mounted towards their lower end in a guide which is in turn reciprocated fore and aft to keep the tine leg vertical while it is in engagement with the ground. The prior art tine legs are articulated to accommodate the differing relative horizontal speeds of the crank shaft and the leg guides which maintain the lower portion of the legs in vertical orientation. Typically when an aerator is required to penetrate the ground at 50 mm spacings, the machine can only move forward 50 mm for every revolution of the crank shaft and therefore a relatively high tine speed is required for reasonable rate of coverage. Due to their mechanical arrangement, prior art machines were subject to higher rates of wear and fixed hole arrangements limited by a single cam.

The reciprocating drive mechanism of the present invention is designed to ameliorate or overcome some or all of these deficiencies in prior art equipment.

### SUMMARY OF THE INVENTION

The present invention consists in a turf aerator with a reciprocating drive mechanism comprising a substantially rigid tine leg pivotally mounted at an upper end to a drive assembly arranged to reciprocate the tine leg along its longitudinal axis, the drive assembly comprising a reciprocating drive member to which the tine leg is pivotally attached at a first point along the drive member, the drive member being pivotally connected at a second point to a first eccentric and at a third point to a second eccentric, the third point being located intermediate the first and second points and the first and second eccentrics being rotated in synchronism, to reciprocate the first point on the drive member both vertically and while reducing the extent of horizontal reciprocation of the first point on the drive member.

In a preferred embodiment, the diameter of the path of rotation of the first eccentric is less than the path of rotation of the second eccentric, and the two eccentrics preferably rotate in the same direction.

In various embodiments, the timing of the eccentrics relative to one another may be varied in order to adjust the operation of the tine leg and in particular, the timing may be adjusted in a given embodiment depending upon the conditions in which the aerator is operating.

The lower end of the tine leg is able to move in a rearward direction to allow the tine to move relative to the machine while the tine is in the ground. The tine leg is biased to a forward position such that when the tine leaves the ground, the tine leg returns toward the forward end of its travel ready for re-engagement with the ground. Biasing may be by a variety of spring arrangements. In one embodiment, the biasing may be by way of a rosta tensioner including a resilient member mounted to a frame of the machine and having a tensioner arm depending from the resilient member and a roller on the end of the tensioner arm, the roller contacting a rear surface of the tine leg when the tine is in its rest position.

The resilient member has a torsional distortion applied to it as the tine leg moves rearward and pushes the roller and tensioner arm rearwards, whereby the resilient member exerts a restoring force on the tine leg via the tensioner arm and roller.

A similar rosta tensioner is also located in front of the tine leg such that the tensioner applies a restoring force in the rearward direction if the tine leg moves forward of its rest position.

In a second, preferred embodiment, the biasing may be effected by way of a resiliently flexibly mounted guide arrangement. The guide arrangement may comprise a pair of rollers. One roller may be mounted on each side of the tine leg. Each roller may be rotatably mounted at the end of a roller arm. A plurality of coil springs may be connected to the roller and/or its arm for drawing the roller into abutment with the tine leg and for exerting a restoring force on the tine leg.

This guide arrangement may also serve to damp rapid horizontal reciprocatory motion of the tine leg when the aerator is rapidly traversing a surface, in use.

### BRIEF DESCRIPTION OF THE DRAWINGS

Embodiments of the invention will now be described by way of example with reference to the accompanying drawings in which:

FIG. 1 illustrates a perspective view of a first embodiment of the invention comprising an aerator arranged to be carried by, or towed behind a vehicle provided with a three point hitch;

FIG. 2 is a side elevation of the aerator mechanism at one point in a cycle of operation;

FIG. 3 is a side elevation of the aerator mechanism of FIG. 2 showing paths of various components during a cycle of operation;

FIG. 4 illustrates a perspective view of a second embodiment of the invention comprising a self propelled turf aerator;

FIG. 5 illustrates a perspective view of a “ride on” embodiment of the invention;

FIG. 6 illustrates a side elevation of the aerator mechanism at its lowest point in its cycle of operation; and

FIG. 7 illustrates a schematic, side view of a guide arrangement of the version of the aerator mechanism of FIG. 6.

### DETAILED DESCRIPTION OF THE PREFERRED EMBODIMENTS

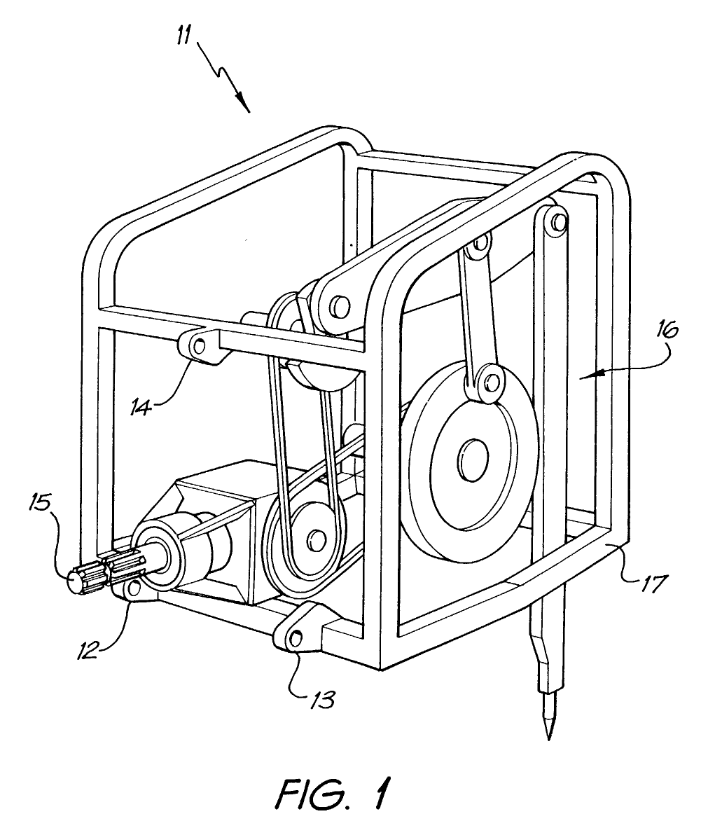

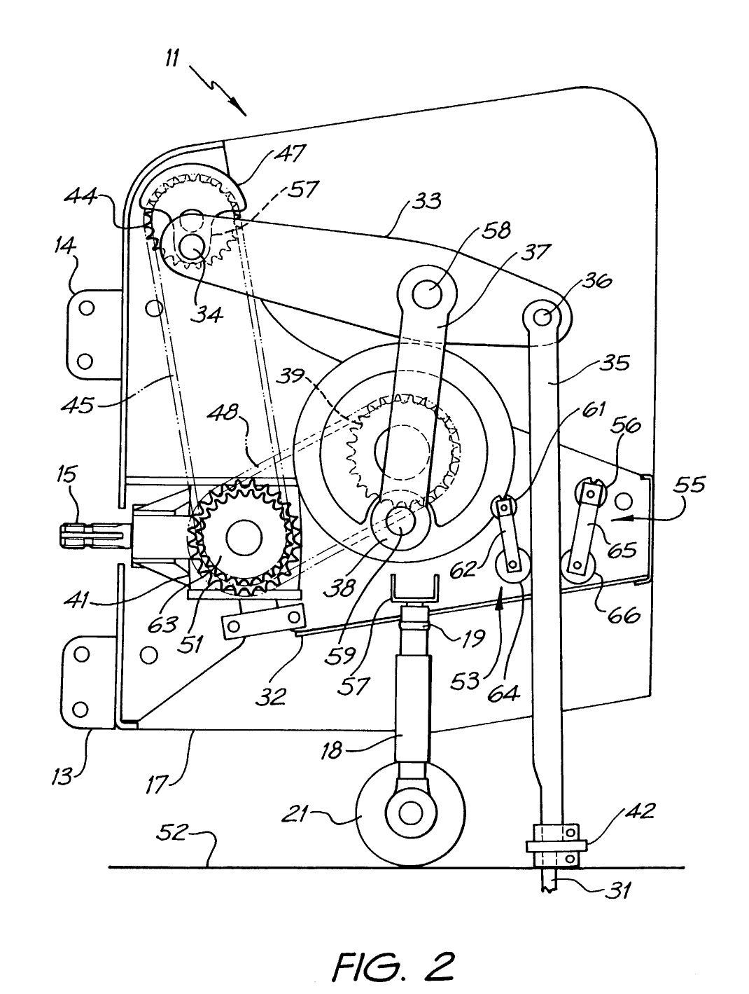

Referring to FIG. 1, a first implementation of the invention is illustrated in which an aerator 11 of the type towed behind a tractor or similar vehicle is shown. In this embodiment, mounting points 12, 13, 14 are provided for attachment to the three point hitch of the towing vehicle and an input shaft 15 is arranged to connect to a power take-off of the towing vehicle. The aerator mechanism 16 is mounted on a chassis 17 and the rear wheels 21 (see FIG. 2) are mounted on a ram 18, extending below a bracket 57 on the chassis 17 and connected by resilient connection 19, such that when the towing vehicle raises the three point hitch, the chassis 17 raises but the wheels or a roller 21 connected to the ram 18 may be lowered to remain in contact with the ground to help support the aerator.

Referring to FIG. 2, an embodiment of the invention is illustrated wherein the aerator mechanism is shown in detail at a point of its cycle where the aerator tines 31 are fully lowered into the turf surface 52. The mechanism is mounted on a frame 32 extending above the chassis 17 and includes a substantially horizontally extending reciprocating drive member 33 connected to a rotating eccentric 57 at one end by a pivotal connection 34, and a substantially vertical tine leg 35 connected at its upper end to the opposite end of the drive member 33 by a pivotal connection 36. The tines 31 are mounted in a tine clamp 42 connected to the lower end of the tine leg 35. A push rod 37 extends between a pivotable connection 58 on the drive member 33 and the pivotable connection 59 on a crank 38 to drive the driver member 33 and thereby the tine leg 35 in reciprocating motion. The crank 38 is connected to a coaxial chain wheel 39 which is driven via chains 48, chain wheel 51 and gearbox 41 and power take-off connection 15 and the eccentric 57 is similarly connected to a coaxial chain wheel 44, chain 45, chain wheel 63 and the gearbox 41. The eccentric 57 also includes a counter balance 47 to minimise vibration caused by the horizontal reciprocation of the drive member 33.

Rotation of the crank 38 causes reciprocation of the driver member 33 via the push rod 37 and subsequently this causes the tine leg to reciprocate substantially vertically. Horizontal reciprocation of the end of the driver member 33 having the connection 36 is effectively damped by the rotation of the eccentric 57 so that a vertical throw of said end of the drive member 33 is much greater than a horizontal throw of said end. Reciprocation is controlled in synchronisation with forward motion of the aerator such that a uniform pattern of holes is punched in the turf surface 52 as the aerator advances. As the implement moves forward with the tines 31 inserted in the ground, the tines move backward relative to the implement. After the tines 31 are retracted from the ground they are moved forward by rosta tensioner 55 until the tine leg 35 strikes the rosta tensioner 53 which decelerates the lower end of the tine leg 35 prior to the tines 31 being reinserted into the turf surface 52. The rosta tensioner 53 includes a torsion block 61 formed of resilient material mounted at one end to the frame 32 (or a bracket or member extending from the frame), a tensioner arm 62 extending from the torsion block 61 and a roller 64 which abuts the tine leg 35 at least when it approaches its forwardmost position. In some embodiments, the roller 64 may remain in contact with the tine leg 35 at substantially all times. However, it will be appreciated that the decelerating force generated by the torsion block 61 will be greater as the roller 64 is moved forward by the tine leg 35.

When the tine leg 35 leaves the ground, its forward motion is effected by a return mechanism comprising the rosta tensioner 55. The rosta tensioner 55 includes a torsion block 56, a tensioner arm 65 and a roller 66 which act similarly to those of the forward rosta tensioner 53. However, rosta tensioner 55 is located behind the tine leg 35 and, preferably, the roller 66 remains in contact with the tine leg 35 substantially all of the time, to push the tine leg forward when it leaves the ground and to continuously and smoothly push it towards the forward extremity of its travel.

The forward rosta tensioner 53 and the rearward tensioner 55 operate against each other with one or the other having a predominant effect on the motion of the tine leg 35 depending upon its position at the time. The relative effect of each rosta tensioner 53, 55 may be varied by varying the stiffness of the torsion blocks 61, 56 and the length of the tensioner arms 62, 65.

When the aerator 11 is set at its normal operating height, the wheels or roller 21 will be in contact with the ground 52 to help support the aerator (or in self-propelled models, to substantially fully support the aerator). When aeration is not in progress, the jack 18 is extended to raise the chassis 17 sufficiently to lift all of the tines clear of the ground, regardless of their position in the aeration cycle. In the case of the tractor mounted model of FIGS. 1 & 2, this would be carried out in conjunction with the raising of the 3 point hitch, connected to the mounting points 12,13 14.

It should be noted that while one tine leg 35 is illustrated for the sake of simplicity, typically 2, 4, or more tine legs and their associated drive mechanisms as described above, will be provided side by side in the chassis 17. These mechanisms are operated at the same speed (they are driven off one gearbox), but will typically have their operating cycles offset such that the load on the drive components is distributed over the cycle and not subjected to the shock of all tines hitting the ground and being driven in simultaneously. This also reduces the lifting force created as the tines are driven into hard earth.

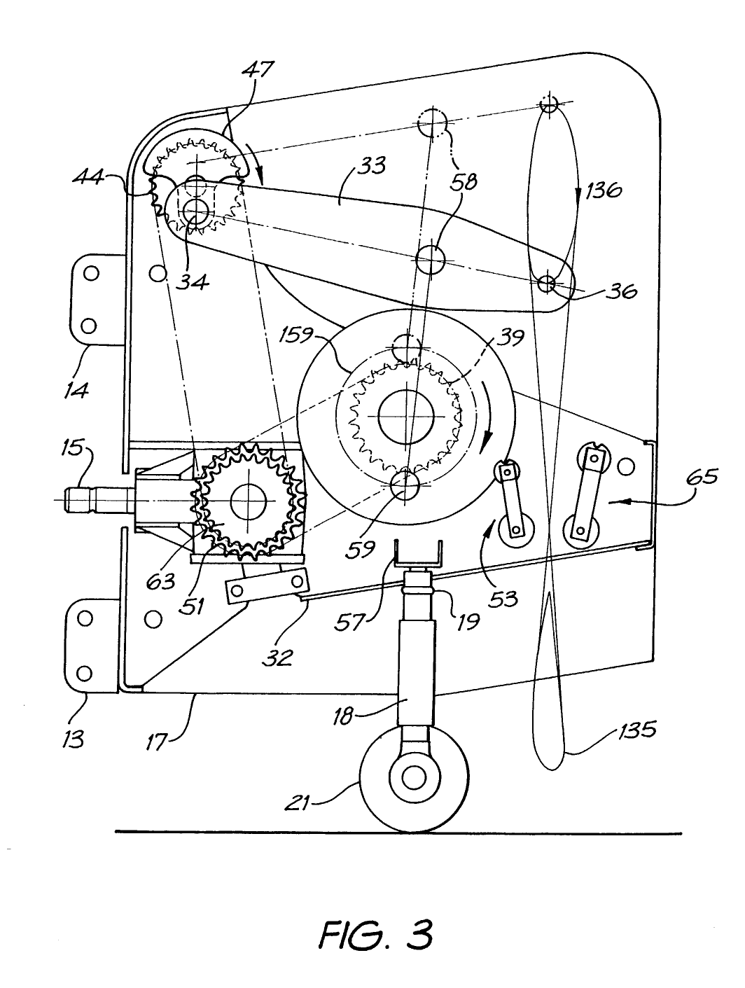

Referring to FIG. 3, the mechanism of FIG. 2 is depicted (with some parts removed) and path tracings for some points in the mechanism superimposed. It will be noted that in operation, as described here, the chain wheel 44 and the chain wheel 39 rotate in the same direction. However, it is also possible to have these wheels counter rotate and/or to alter their timing relative to one another, to vary the hole pattern, or tine penetration and exit characteristics. However, in the present embodiment, the chain wheels are timed to operate in complete synchronism with both reaching bottom dead centre at the same time.

Under these circumstances, the pivot point 36 at the top of the tine leg follows the path 136 during one cycle of operation, and a point near the lower end of the tine leg will follow the path 135 assuming no ground engagement.

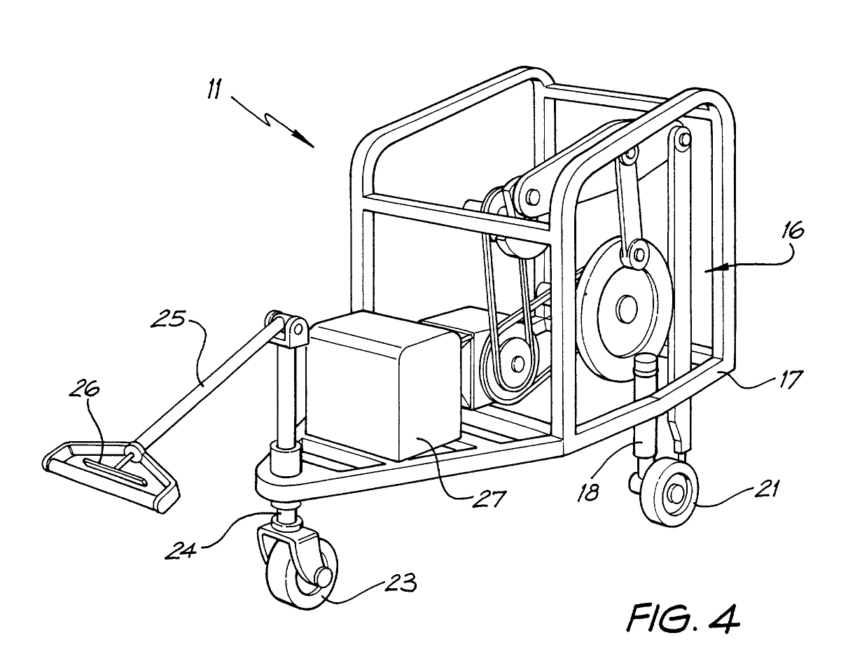

Turning to FIG. 4, a self propelled, “walk-behind” version of the aerator is illustrated. In this embodiment, again the aerator mechanism 16 is mounted on a chassis 17 and ram 18 resiliently connected to the chassis carries the wheels on a roller 21. In this embodiment, the front of the implement is supported on a single or double wheel 23 mounted at the lower end of a post 24 rotatably mounted through the forward end of the chassis 17.

A control arm 25 extends from and is pivotally connected to the upper end of the post 24 and includes a plurality of control levers 26 used to operate the implement. A motor 27 is provided to drive the aerator mechanism and to propel the implement via the rear wheels 21.

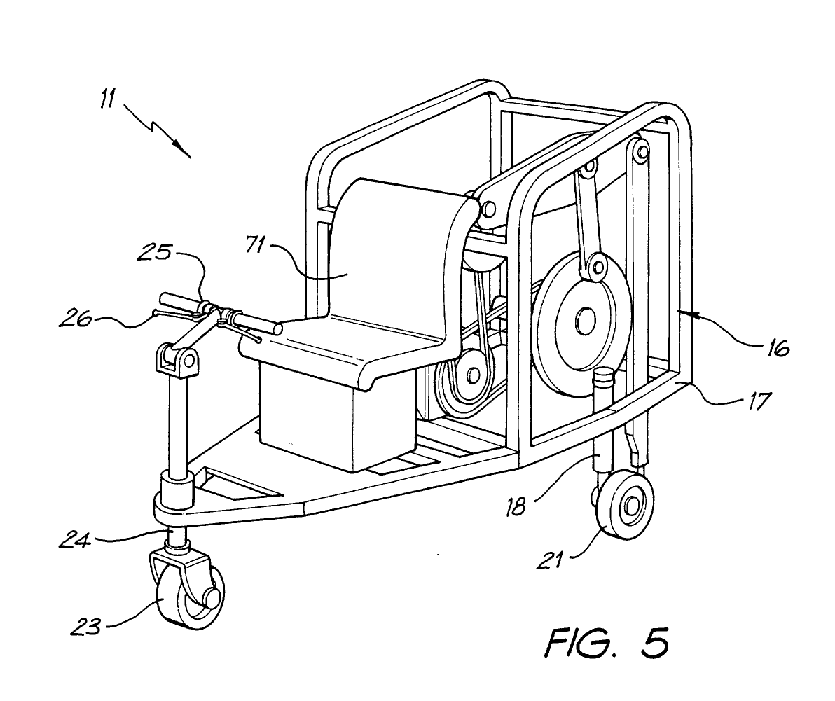

Referring to FIG. 5, a “ride on” version of the aerator is illustrated, in which the forward end of the chassis 17 is elongated and an operator's seat 71 is provided behind the operating arm 25.

To avoid problems caused by lubricating oil, all of the pivot points and drive shaft bearings in the mechanisms are manufactured with self lubricating bushes formed of lubrication impregnated nylon and sealed bearings are used wherever required.

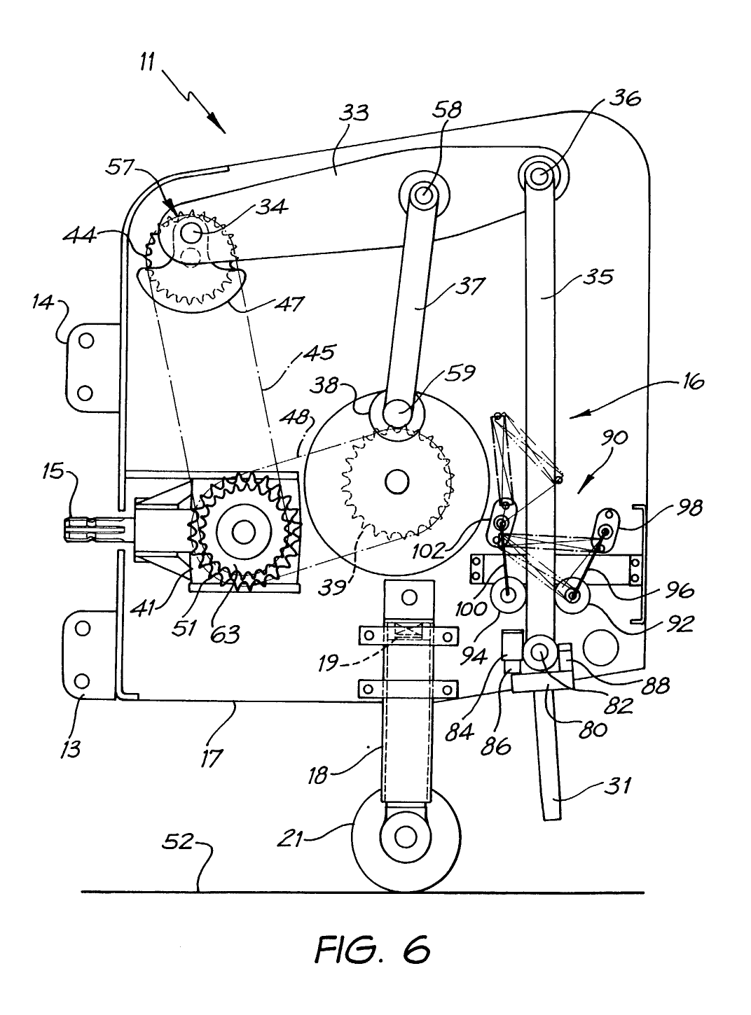

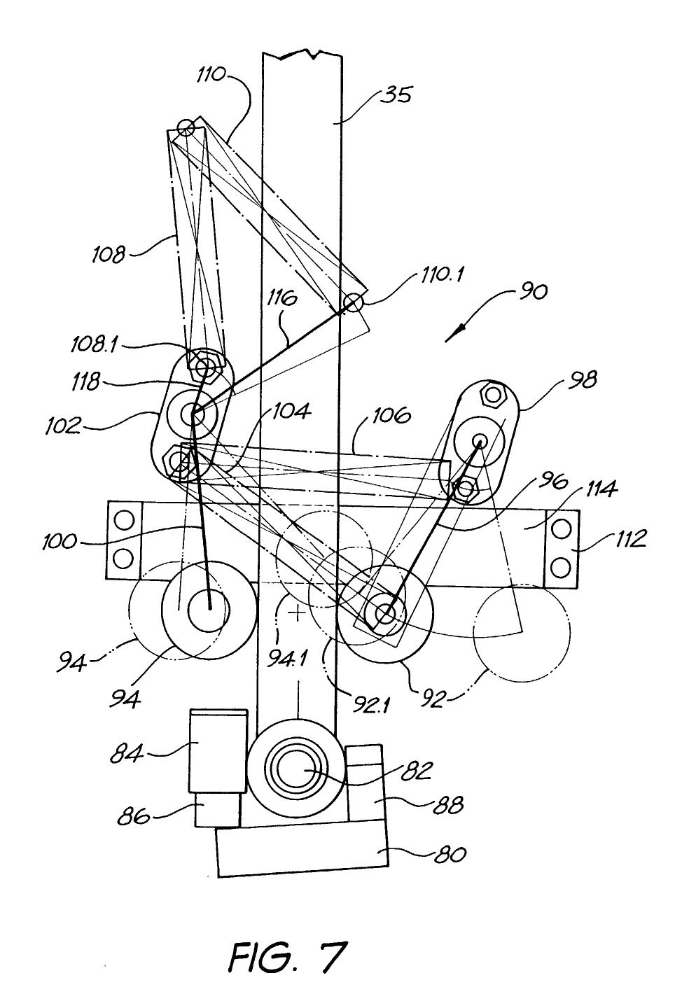

Referring now to FIGS. 6 and 7, a further embodiment of the aerator 11 illustrated in FIGS. 1, 2 and 3 is shown. With reference to FIGS. 1, 2 and 3 like reference numerals refer to like parts, unless otherwise specified. The operation of the aerator mechanism 16 shown in FIG. 6, and in particular the displacement of the tine leg 35 is substantially as described above with reference to FIGS. 2 and 3.

However, in this embodiment of the invention, each tine leg 31 is mounted on a tine cap 80. The tine cap 80, in turn, is pivotally mounted via a pivot point 82 to a bottom of the tine leg 35.

A spring housing 84 is mounted ahead (in the direction of movement of the aerator 11) of the pivot point 82. A spring 86 projects from the spring housing 84 and bears down on the tine cap 80. A resiliently flexible pad 88 is mounted rearwardly of the pivot point 82.

To ensure vertical insertion of the tine 31 into the surface 52, a longitudinal axis of the tine 31 is slightly offset with respect to a longitudinal axis of the tine leg 35.

In this embodiment, instead of the rosta tensioners 53 and 55, a guide mechanism 90 is provided for guiding the lower end of the tine leg 35 and to ensure the required insertion into, and retraction from, the surface 52 of the tine 31.

The guide arrangement 90 comprises a pair of rollers 92 and 94. The roller 92 is mounted behind the tine leg 35 with the roller 94 being mounted ahead of the tine leg 35. The roller 92 is mounted via an arm 96, pivotally, on a bracket 98. Similarly, the roller 94 is mounted pivotally via an arm 100 to a bracket 102. The roller 92 is biased to the position shown in solid lines in FIG. 7 by a pair of springs 104 and 106 with the spring 104 having a greater spring force than the spring 106. The maximum arc of travel of the roller 92 is shown in dotted lines in FIG. 7 of the drawings. Similarly, the roller 94 is biased to the position shown in solid lines in FIG. 7 of the drawing by a pair of springs 108 and 110 with the spring 110 having a greater spring force than the spring 108.

It is to be noted in FIG. 7 of the drawings that the arrangement of the springs 104, 106, 108 and 110 are shown schematically. For example, an end 110.1 of the spring 110 is connected to the bracket 102 by an arm 116. Likewise, an end 108.1 of the spring 108 is connected to the bracket 102 by an arm 118. In practice, the arms 116 and 118 overlie each other and extend substantially parallel to each other. The arm 116 is fast with the bracket 102 to pivot together with the bracket 102. A stopper (not shown) is provided to limit the extension of the spring 110. A stopper (also not shown) is also provided for limiting the extension of the spring 104. Both lighter springs 106 and 108 serve to keep their respective rollers 92 and 94 in contact with the tine leg 35 to prevent lash of the leg 35.

It will be apparent that, were the roller 94 absent, the rest position of the roller 92 would be the position 92.1. Similarly, if the roller 92 were absent, the rest position of the roller 94 would be the position 94.1.

The rollers 92 and 94 with their associated springs ensure that the tine legs 31 follow the narrow elliptical path 135 illustrated in FIG. 3 of the drawing to ensure that substantial verticality of the tines 31 is maintained as the tines 31 are inserted into, and removed from, the turf 52 when the aerator 11 traverses the turf 52.

By adjusting the ground speed of the aerator 11 and the strength of the springs 104, 106,108 and 110, the ground spacing of holes created by the tines 31 can be varied. For very rapid traversal of the turf 52, chatter of the tine legs 35 is inhibited by means of the spring biased rollers 92 and 94. The tine legs 35 are also constrained against lateral movement by means of a lined bracket 112 through which the tine leg 35 passes. The bracket 112 is lined with a plastics lining 114 which is also self lubricating. For example, the lining 114 is of PTFE.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A reciprocating drive mechanism comprising
a substantially rigid tine leg pivotally mounted at an upper end to a drive assembly arranged to reciprocate the tine leg along its longitudinal axis, the drive assembly comprising
a reciprocating drive member to which the tine leg is pivotally attached at a first point along the drive member, the drive member being pivotally connected at a second point to a first eccentric and at a third point to a second eccentric, the third point being located intermediate the first and second points and the first and second eccentrics being rotated in synchronism, to reciprocate the first point on the drive member both vertically and while reducing the extent of horizontal reciprocation of the first point on the drive member.

2. The reciprocating drive mechanism of claim 1, wherein the diameter of the path of rotation of the first eccentric is less than the path of rotation of the second eccentric.

3. The reciprocating drive mechanism of claim 1 or 2, wherein and the two eccentrics rotate in the same direction.

4. The reciprocating drive mechanism of claim 1, 2, or 3, the timing of the eccentrics relative to one another may be varied in order to vary the operation of the tine leg.

5. The reciprocating drive mechanism as claimed in any one of claims 1 to 4, wherein the lower end of the tine leg is free to move in a rearward direction to allow the tine to move relative to the machine while the tine is in the ground.

6. The reciprocating drive mechanism as claimed in claim 5, wherein biasing means are provided to bias the tine leg to a forward position.

7. The reciprocating drive mechanism as claimed in any one of claims 1 to 6, wherein biasing is achieved by a spring.

8. The reciprocating drive mechanism as claimed in any one of claims 1 to 6, wherein biasing means comprises a rosta tensioner including a resilient member mounted to a frame of the machine, a tensioner arm depending from the resilient member, and a roller on the end of the tensioner arm, the roller contacting a rear surface of the tine leg when the tine is in its rest position.

9. The reciprocating drive mechanism as claimed in claim 8, wherein the resilient member has a torsional distortion applied to it as the tine leg moves rearward and pushes the roller and tensioner arm rearwards, whereby the resilient member exerts a restoring force on the tine leg via the tensioner arm and roller.

10. The reciprocating drive mechanism as claimed in any one of claims 1 to 6, wherein a second biasing means is provided to apply a restoring force to the tine leg in the rearward direction if the tine leg moves forward of its rest position.

11. The reciprocating drive mechanism as claimed in claim 10, wherein the second biasing means is a rosta tensioner located in front of the tine leg.

12. The reciprocating drive mechanism as claimed in any one of claims 1 to 6, wherein the biasing means comprises a resiliently flexibly mounted guide arrangement.

13. The reciprocating drive mechanism as claimed in claim 12, wherein the guide arrangement comprises a pair of rollers.

14. The reciprocating drive mechanism as claimed in claim 13, wherein one roller is mounted on a forward side of the tine leg and another roller is mounted on a rearward side of the tine leg.

15. The reciprocating drive mechanism as claimed in claim 14, wherein each roller is rotatably mounted at the end of a roller arm.

16. The reciprocating drive mechanism as claimed in claim 15, wherein the rollers are biased into abutment with the tine leg by a plurality of springs to exert a restoring force on the tine leg.

17. The reciprocating drive mechanism as claimed in claim 16, wherein the springs are coil springs and are each connected to one of the rollers and/or one of the roller arms.

18. The reciprocating drive mechanism as claimed in claim 17, wherein the guide arrangement also serves to dampen rapid horizontal reciprocatory motion of the tine leg when the aerator is rapidly traversing a surface, in use.
